(19) United States
(12) Patent Application Publication
(10) Pub. No.: US 2018/0025325 A1
(43) Pub. Date: Jan. 25, 2018

(54) ELECTRONIC CALENDAR SCHEDULING INCORPORATING LOCATION AVAILABILITY OF INVITEE(S)

(71) Applicant: INTERNATIONAL BUSINESS MACHINES CORPORATION, Armonk, NY (US)

(72) Inventors: Christopher M. BOSKO, Raleigh, NC (US); Bryan D. OSENBACH, Cary, NC (US); Jeffrey B. SLOYER, Cary, NC (US); Ramratan VENNAM, Colfax, NC (US)

(21) Appl. No.: 15/214,672

(22) Filed: Jul. 20, 2016

(51) Int. Cl. G06Q 10/10; G06Q 10/02

(52) U.S. Cl. CPC G06Q 10/1095; G06Q 10/02

(57) ABSTRACT

Electronic calendar scheduling is provided with information on location-availability of invitees. The scheduling method includes, for instance, initiating scheduling, via an electronic calendar system, a calendar event at a location for an event at a future time. The initiating scheduling includes: identifying one or more invitees to the calendar event; determining, via the electronic calendar system, location availability of the invitee(s) for the event at the future time; and sending a calendar invite to the invitee(s) based, at least in part, on the one or more invitees being location available for the event at the location at the future time. The determining location availability may include ascertaining geographically a scheduled location of an invitee at the future time using the electronic calendar system. Further, schedule location availability information for the invitee(s) at the future time may be viewed to facilitate the scheduling process using the electronic calendar system.

### BACKGROUND

An electronic calendar system maintains useful information for a user, and allows maintenance of a personal schedule of activities, such as meeting appointments, teleconference schedules, etc.

Typical electronic calendar systems allow users to send electronic invitations to other users, and for a user receiving an electronic calendar invitation, to either accept or decline the invitation. An invitation typically includes a description of the event, a location of the event, and a scheduled start and end time of the event. An invitation decline message may be returned to the user that issued the invitation when the invitation is declined by an invited user. Likewise, an invitation acceptance message may be returned to the user that issued the invitation when the user accepts the invitation. When a user accepts an invitation, the scheduled event is recorded in the electronic calendar of the accepting user. Additionally, a record of the calendar of the user that issued the invitation may be updated to reflect the expected attendance by the accepting user. Accordingly, the calendar of the user that issued the invitation typically includes an indication of the number of users that have accepted the invitation, and the inviter-user can plan for the event in response to the anticipated attendance.

The ability to provide electronic calendar scheduling enhancements is an area of interest and continued research for, for instance, establishing commercial advantage in the industry.

### SUMMARY

The shortcomings of the prior art are overcome and additional advantages are provided through the provision of a method which includes initiating scheduling, using an electronic calendar system, a calendar event for an event at a location at a future time. The initiating scheduling includes, for instance: identifying one or more invitees to the calendar event; determining, via the electronic calendar system, location availability of the one or more invitees for the event at the future time; and sending a calendar invite to the one or more invitees based, at least in part, on the one or more invitees being location available for the event at the location at the future time.

In another aspect, a system of electronic calendar scheduling is provided. The system includes a memory, and a processing circuit communicatively coupled with the memory. The system performs a method, including initiating scheduling of a calendar event for an event at a location at a future time. The initiating scheduling includes: identifying one or more invitees to the calendar event; determining location availability of the one or more invitees for the event at the future time; and sending a calendar invite to the one or more invitees based, at least in part, on the one or more invitees being location available for the event at the location at the future time.

In one or more further aspects, a computer program product for electronic calendar scheduling is provided. The computer program product includes a computer readable storage medium having a processing circuit and storing instructions for execution by the processing circuit for performing a method, which includes initiating scheduling of a calendar event for an event at a location at a future time. The initiating scheduling includes: identifying one or more invitees to the calendar event; determining location availability of the one or more invitees for the event at the future time; and sending a calendar invite to the one or more invitees based, at least in part, on the one or more invitees being location available for the event at the location at the future time.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a network of data processing systems which may implement an electronic calendar system incorporating invitee(s) location-availability processing, in accordance with one or more aspects of the present invention;

FIG. 2 is a block diagram of a data processing system in which an electronic calendar system with invitee(s) location-availability processing may be implemented, in accordance with one or more aspects of the present invention;

FIG. 3 is a diagram illustrating one embodiment of system components for managing an electronic calendar system with invitee-location-availability calendaring, in accordance with one or more aspects of the present invention;

FIG. 4 is a block diagram of one embodiment of an electronic calendar system with invitee(s) location-availability processing, in accordance with one or more aspects of the present invention;

FIG. 5 depicts one embodiment of a graphical user interface for creating a calendar entry in an electronic calendar system, wherein location information may be specified, or individual invitee location-availability viewed, in accordance with one or more aspects of the present invention;

FIGS. 6A-6C depict further examples of graphical user interfaces with a calendar entry expanded to view individual invitees' time availability, and optionally, location-availability, in accordance with one or more aspects of the present invention;

FIG. 7 depicts one embodiment of a process for scheduling a calendar event using an electronic calendar system, and taking into consideration location-availability of one or more invitees to the event, in accordance with one or more aspects of the present invention;

FIG. 8 depicts one embodiment of a cloud computing environment, which may implement or be used in association with one or more aspects of the present invention; and

FIG. 9 depicts an example of extraction model layers, which facilitate or implement calendar processing with invitee location-availability information, in accordance with one or more aspects of the present invention.

### DETAILED DESCRIPTION

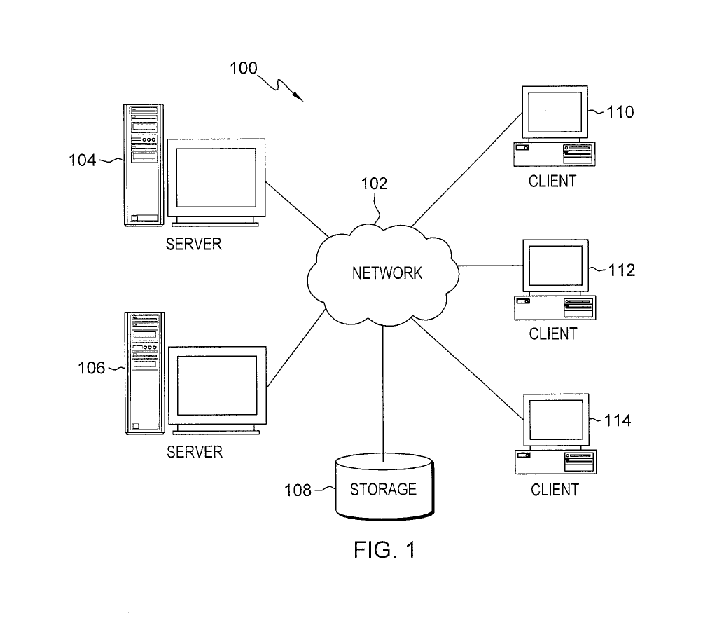

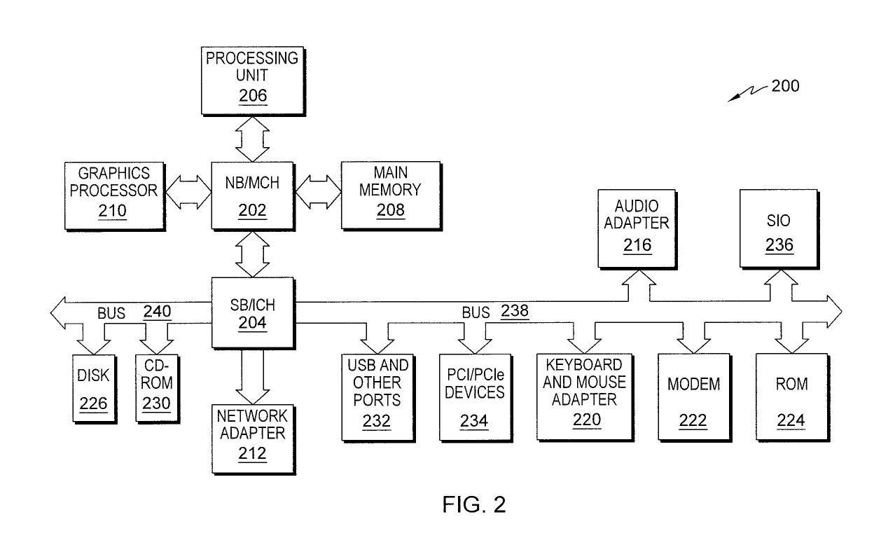

With reference to the figures, and in particular FIGS. 1-2, exemplary diagrams of data processing environments are initially provided in which illustrative aspects of the present invention may be implemented. Note in this regard that FIGS. 1-2 are only exemplary, and are not intended to imply any limitation with regard to the environments in which different aspects may be implemented. Many modifications to the depicted environments may be made.

Referring to FIG. 1, network data processing system 100 may include multiple computers, and a network 102. Network 102 may be any medium used to provide communications links between various devices and computers connected together within network data processing system 100. For instance, network 102 may include connections, such as wires, wireless communication links, fiber optic cables, etc.

In the depicted system, servers 104, 106 connect to network 102, along with a storage unit 108, and clients 110, 112, 114. Clients 110, 112, 114 may be, for example, personal computers, network computers, mobile devices, etc. In operation, server 104 may provide data, such as boot files, operating system images, and applications to clients 110, 112, and 114, and further clients 110, 112, 114 may be clients to server 104 in one example only.

In one or more embodiments, clients 110, 112, and 114 may include electronic calendar systems such as described herein, in which data for the calendars may be stored on server 104. Further, server 104 may provide different scheduling processes for events in these calendars. Alternatively, depending on the implementation, calendar information may be stored at clients 110, 112, and 114. With this type of implementation, server 104 may provide services to allow clients 110, 112, and 114 to exchange calendar invitations and/or other information for the calendars. Note that network data processing system 100 may include fewer servers and clients, or additional servers, clients, or other devices (not shown), such as mobile or wireless devices.

In one or more embodiments, network data processing system 100 may incorporate, or utilize, the Internet, with network 102 representing a potentially worldwide collection of networks and gateways that use the Transmission Control Protocol/Internet Protocol (TCP/IP) suite of protocols to communicate with one another. As known, the Internet includes a backbone of high-speed data communication lines between major nodes or host computers, comprising millions of commercial, governmental, educational and other computer systems that route data and messages. Of course, network data processing system 100 may also be implemented as a number of different types of networks, such as for example, an intranet, a local area network (LAN), a wide area network (WAN), a wireless network, etc. FIG. 1 is intended as one example only, and not as an architectural limitation for the different illustrative aspects of the electronic calendaring disclosed herein.

Referring to FIG. 2, a block diagram of a data processing system is shown in which illustrative aspects of the present invention may be implemented. Data processing system 200 may be one example of a computer, such as server 104 or client 110 in the system of FIG. 1, and may include computer usable program code or instructions implementing processes such as disclosed herein.

In the depicted example, data processing system 200 includes a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, a local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system, such as a Microsoft™ Windows™ system (Microsoft and Windows are trademarks of Microsoft Corporation in the United States, other countries, or both). An object oriented programming system, such as the Java™ programming system, may run in conjunction with the operating system and provide calls to the operating system from Java™ programs or applications executing on data processing system 200. (Java™ and other Java™ based trademarks are trademarks of Sun Microsystems, Inc. in the United States, other countries, or both.)

Instructions for the operating system, the object-oriented programming system, and applications or programs may be located on storage devices, such as hard disk drive 226, and may be loaded into main memory 208 for execution by processing unit 206. The processes of the illustrative aspects discussed herein may be performed by processing unit 206 using computer implemented instructions, which may be located in a memory such as, for example, main memory 208, read only memory 224, or in one or more peripheral devices.

The hardware embodiments depicted in FIGS. 1-2 may vary depending on the desired implementation. Other internal hardware or peripheral devices, such as flash memory, equivalent non-volatile memory, or optical disk drives and the like, may be used in addition to or in place of certain hardware depicted in FIGS. 1-2. Also, the processes of the illustrative aspects described herein may be applied to other hardware environments, such as to a multiprocessor data processing system.

In one or more implementations, data processing system 200 may be a mobile device, and be generally configured with flash memory to provide non-volatile memory for storing operating system files and/or user-generated data. A bus system may include one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. Those skilled in the art should note that the depicted system examples of FIGS. 1-2, as well as other examples referenced herein, are not meant to imply architectural limitations. For example, as briefly noted, data processing system 200 may be implemented as part of a tablet computer, laptop computer, mobile telephone, personal digital assistant (PDA), wireless computer, etc.

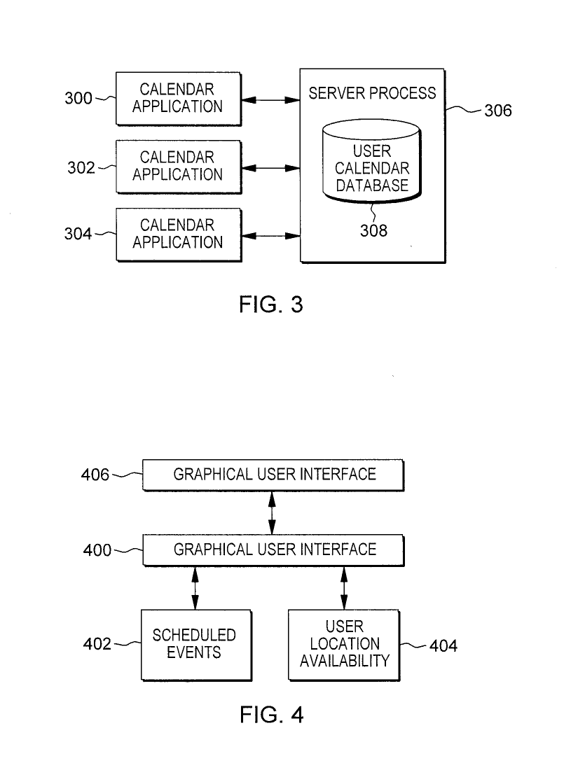

Referring to FIG. 3, a diagram illustrating one embodiment of an electronic calendar system used in scheduling or managing calendar appointments is provided, which may incorporate one or more aspects of the present invention. In this example, calendar applications 300, 302 and 304 may be client applications to a server process 306. These calendar applications may be, for example, stand-alone applications providing electronic calendar system functions. Alternatively, these calendar applications may be processes or applications integrated within one or more other applications or programs.

By way of example, calendar applications 300, 302, and 304 may be implemented using Microsoft™ Outlook™. These applications also may be implemented using IBM® Verse™. (IBM® and Verse™ are trademarks of International Business Machines Corporation in the United States, other countries, or both.) In yet another implementation, these applications may be web-based applications. When implemented using existing applications, calendar applications 300, 302, and 304 may be modified to include processes to manage calendar conflicts, in terms of time and location, for one or more calendar invitations to be processed. In other implementations, these processes and conflicts may be managed on a server.

Depending on the particular implementation, calendar entries may be stored at the data processing system on which the calendar application executes. In one or more other implementations, the calendars for users may be stored in a database, such as user calendar database 308. When calendar applications 300, 302, and 304 store entries locally, server process 306 may serve to facilitate the exchange of calendar invitations for appointments. In this type of implementation, server process 306 might be an email server process.

In the illustrated example, a user of calendar application 300 may receive one or more calendar invitations for events from other users using calendar applications 302 and 304. These calendar invitations may be stored in a queue for processing by the user. Conventionally, electronic calendar systems schedule calendar events with reference to date and time availability of the invitees. Essentially, existing calendar views provide a user with an ability to review calendar invitations that may have conflicting meeting times, with a conflicting meeting time occurring when two calendar invitations occur at the same time, or at least partially overlap in time on a given date.

By way of enhancement, when trying to schedule an event, it may be ideal if each invitee be at the same physical location during the event. However, many peoples' schedules require them to travel extensively, and in such cases, it may be difficult to arrange the event using existing electronic calendaring systems. Typically, in such cases, the invitee may be invited by the system to attend the meeting remotely, such as over the phone, from another location.

Advantageously, disclosed herein, in one or more aspects, is an electronic calendaring system and calendaring approach which make use of an invitee's scheduled location availability when scheduling a calendar event. Note in this regard that scheduling or initiating scheduling may refer herein to creating or managing scheduling of an electronic calendar event, such as a meeting, appointment, etc., for one or more individuals, users, attendees, etc., referred to herein as “invitees”. The invitees may include, in one or more implementations, a scheduler of the event, such as a user of the calendar system or application initiating scheduling of the event.

Generally stated, disclosed herein are a method, system, and computer program product for facilitating calendar scheduling, using an electronic calendar scheduling system, and accounting for scheduled geographic location availability of one or more invitees to an event. For instance, a method is provided which includes initiating scheduling, via an electronic calendaring system, a calendar event for an event at a location at a future time. The initiating scheduling may encompass creating or managing the calendar event, and include: identifying one or more invitees to the calendar event; determining, via the electronic calendar system, location availability of the one or more invitees for the event at the future time; and sending a calendar invite to the one or more invitees based, at least in part, on the one or more invitees being location available for the event at the location at the future time.

In one or more implementations, the above-noted method is an enhancement on conventional electronic calendar scheduling systems, which may also filter, for instance, for data and time availability. In accordance with aspects of the present invention, the scheduled location availability for the invitees, or more generally, for user of the calendar application, is also tracked and considered in determining whether to schedule the calendar event.

In one or more implementations, initiating scheduling of a calendar event may further include specifying by a scheduler the location for the event using the electronic calendar system, wherein the location is a specified geographic location for the event. By way of example, the scheduler may be a user of a calendar application initiating the calendar event, and the specified geographic location may be, for instance, one or more specified geographic locations where the invitee is to attend the event. By way of specific example, invitees may be invited to join an event by attending the event at one or more geographic locations, with, for instance, an address and room specified for each geographic location.

In one or more embodiments, the initiating scheduling may further include selectively indicating which invitee or invitees, of the one or more invitees, is required to physically attend the event at the specified geographic location(s). Further, the determining may include ascertaining, via the electronic calendar system, for an invitee of the one or more invitees, a scheduled location of each invitee at the future time. As noted, the electronic calendar system is modified as described to provide tracking of a user's scheduled geographic location at future times. By way of further example, determining location availability may include ascertaining, via the electronic calendar system, for each invitee of the one or more invitees, the invitee's scheduled location at the future time, and proceeding with the sending of the calendar invite when each invitee's scheduled location matches at least one location for the event at the future time. In such a case, the location of the event may be set after consulting the invitee's scheduled location availability within the electronic calendar system. By way of example, a user scheduling a calendar event may be located in geographic location A, while all other invitees are going to be at geographic location B at the future time. In such a case, the scheduler, who is assumed in this example to also be an invitee, may select the event location to be location B, and plan on traveling to that location at the future time in order that all attendees may be in the same physical location for the event.

In one or more implementations, initiating scheduling of the calendar event may include displaying scheduled location availability information for the one or more invitees at the future time for viewing by a scheduler of the calendar event. For example, if the scheduler is unable to schedule the calendar event for the desired date, time and location, then the electronic calendar system may be prompted to provide the scheduler with scheduled location availability information for each invitee of the calendar event, and thereby allow the scheduler to determine whether to proceed with the event at the desired date, time and location, with less than all invitees physically present.

In addition to allowing the scheduler or user of the calendar application to view scheduled location availability information for the invitees, the electronic calendar system may be used to designate which invitee of a plurality of invitees is to be physically present at the location, and even to evaluate the scheduled location availability information for those invitees in determining a location for the calendar event.

As summarized, methods, systems, and computer program products are disclosed herein for enhancing an electronic calendar system, and which allow a scheduler or user of a calendar application to, for instance, specify a required location for an event, filter for an invitee's location availability based on the required location, and/or to view an invitee's scheduled location availability information for a future date and time, to facilitate managing scheduling of the event. Once a calendar invitation is received by an invitee, the invitation may indicate to the invitee that the invitee is required to be at the specified location for the meeting, as opposed to attending remotely. Advantageously, when a user or scheduler using an electronic calendar scheduling system with invitee location availability, is attempting to schedule or manage a calendar invitation, the scheduler may be allowed to specify that the invitees are required to be present at a certain location. With this information, the electronic calendar scheduling system is then able to search the scheduled location availability information for each invitee, and determine whether or when the event may proceed based, for instance, on date, time and invitee location availability.

Advantageously, in one or more implementations, the electronic calendar scheduling system described herein also allows a scheduler to make a required presence designation for the event on a per invitee basis. Also, as noted above, the electronic calendar system described herein may allow a scheduler to designate multiple geographic locations where an event invitee may go to attend the event.

One approach for a scheduler to specify that attendance is required for a particular invitee would be to check a box next to the event location, or to use a drop-down menu next to the invitee's name, etc. When creating or managing a calendar invite, the scheduler is provided with a means to readily view which invitees are available at a certain location at the future date and time. This location availability processing may be implemented in a manner similar to time availability. When looking at scheduled location availability for one or more invitees, feedback could be provided similar to a busy/available indicator, like a bar graph. For instance, if one or more of the invitees are available at a specified location, then those invitees' availability table might appear a specific color, such as green, while other invitees not available at the specified location might appear a different color, such as red.

In one or more implementations, once a calendar event is selected, and invitees are marked as required to attend in a specific location, a calendar invite may query each invitee to confirm that the invitee would be at the designated location during the proposed date and time. By way of enhancement, the location availability information may be expanded beyond a simple busy/available indication, such as the above-noted red/green color scheme. For instance, it could, based on user privacy settings, display specific, anticipated location information for the invitee(s).

By way of further explanation, FIG. 4 depicts a diagram of an electronic calendar system, which includes a calendar application 400, similar to calendar applications 300, 302 or 304 of FIG. 3. In this example, however, calendar application 400 may access entries for events or appointments already in a calendar for a user, as scheduled events 402, as well as the user's location availability information 404, which may also be tracked by the calendar application. The user or scheduler of a calendar event may use the electronic calendar system of FIG. 4 to view, via a graphical user interface 406, availability information of one or more invitees to a proposed calendar event, including date, time, and location availability information, as described herein.

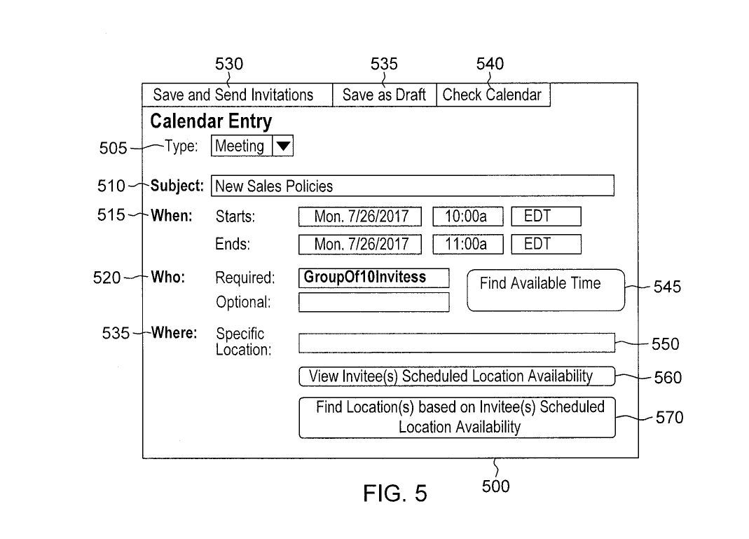

FIG. 5 depicts one example of a graphical user interface window 500 of an electronic calendar system. Graphical user interface window 500 may be displayed to a user, for instance, a scheduler, of the electronic calendar system through, for example, a monitor or other display device. Using graphical user interface window 500, a scheduler may initiate scheduling (for instance, create or manage) a new calendar event in the electronic calendar system. As shown, graphical user interface window 500 may include an area 505 for the user to select the type of event, an area 510 for the user to input a subject of the event, an area 515 for the user to input or modify a tentative time for the event, an area 520 for the user to indicate invitees selected for the event, and an area 525 for the user to specify a location for the event. Additionally, the graphical user interface window 500 may include a button 530 to save the event in the electronic calendar system, and to send invitations to indicated invitees, a button 535 to save the event as a draft, and a button 540 allowing the user to check their own schedule stored in the electronic calendar system.

A user may specify the invitees for the event in the graphical user interface window 500 by, for instance, inputting the name of a predefined group. The predefined group may include an e-mail address, a system nickname, and/or account information for each of the invitees associated with the predefined group. Additionally, or alternatively, a user may specify the invitees for the event in window 520 individually, using an e-mail address, a system nickname, and/or other account information.

In addition, the graphical user interface window 500, in this example, includes a “find available time” button 545, which may trigger the electronic calendar system to perform the function of searching availability associated with each of the invitees' specified for the event to determine a number of periods of availability. The periods of availability may be periods of time during which a significant number of the invitees are determined to be available. The electronic calendar system may be configured to find a specified number of periods of availability (e.g., then periods of availability that maximize the number of invitees that are available during at least one of the periods of availability) or, alternatively, to find a smallest number of periods of availability, such that each of the invitees is available during at least one of the periods of availability.

Additionally, as described herein, invitee location availability information may be considered in determining when and/or where to schedule a calendar event, in accordance with one or more aspects of the present invention. For instance, in one or more embodiments, the scheduler may specify a particular location 550, which the electronic calendar system then uses to compare each invitee's scheduled location availability information against, and determine, along with time availability, when the invitees may physically attend the event at the specified location. In combination with this, or alternatively, the graphical user interface window 500 may be provided with a “view invitee(s) scheduled location availability” button 560, as well as a “find location(s)” button 570, based on invitees' scheduled location availabilities. As explained herein, these additional buttons might allow the scheduler to view invitee-specific information, based on scheduled location availability of the invitees to the calendar event.

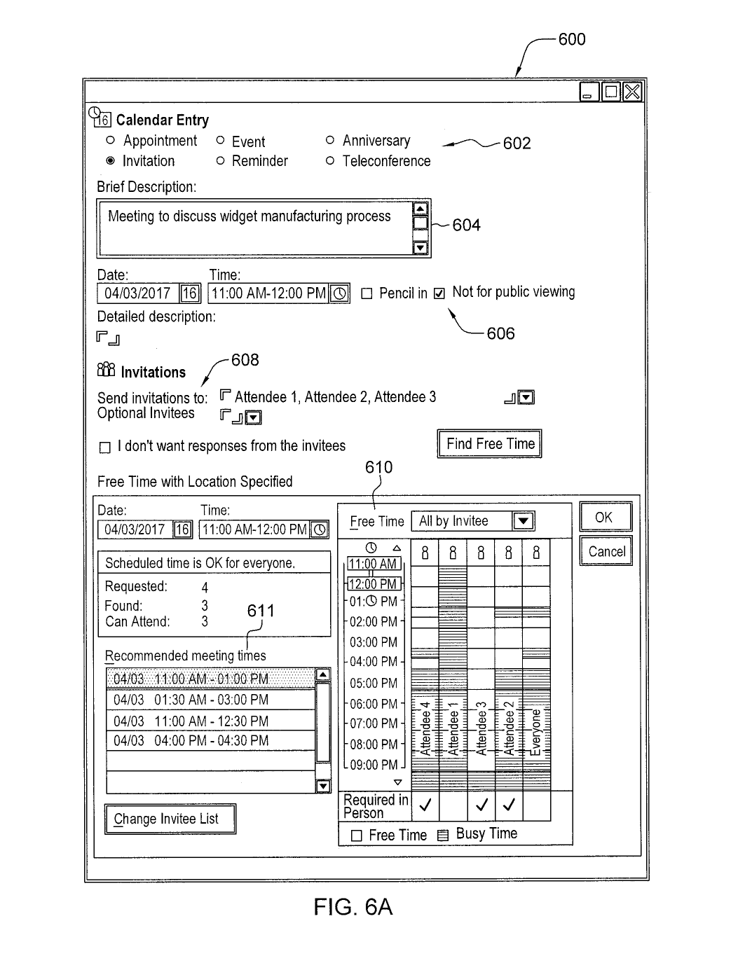

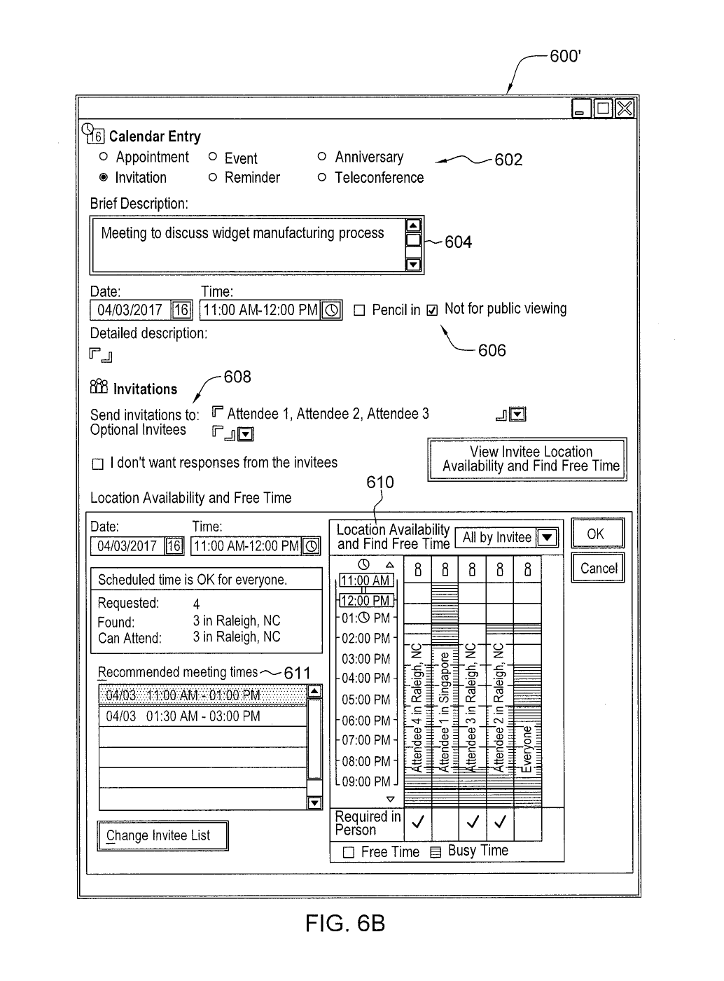

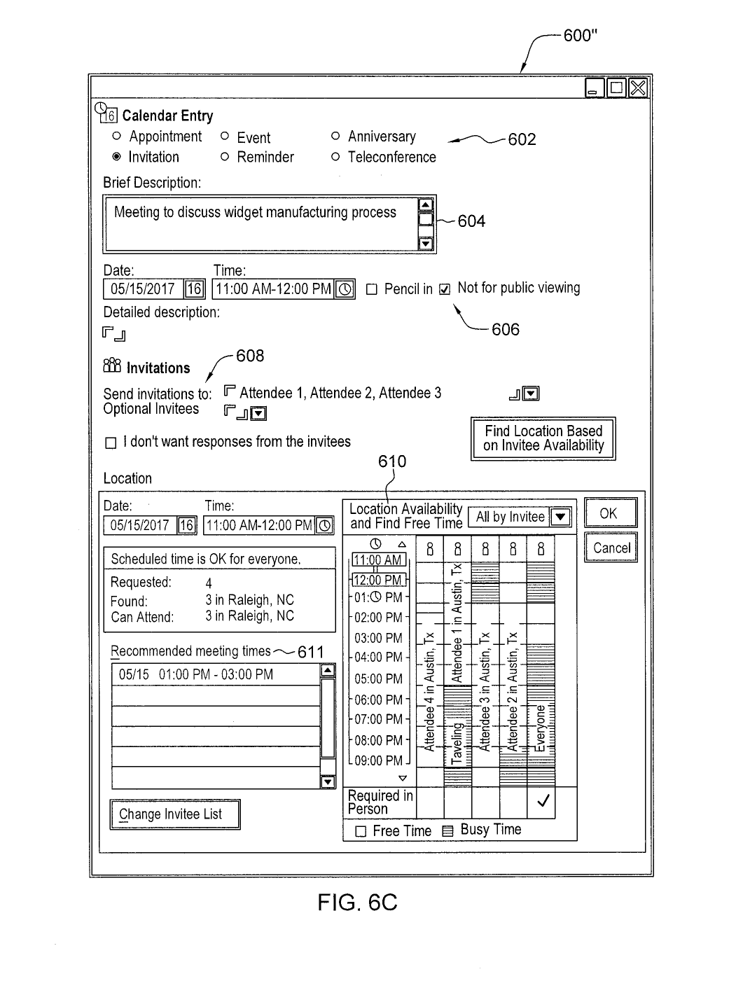

FIGS. 6A-6C depict further examples of a graphical user interface window 600, illustrating one of many possible calendar application entry pages, in accordance with one or more aspects of the present invention. The calendar entry page depicted in the figures may be modified pages from, for instance, an IBM® Verse™ electronic calendar system. These figures are only exemplary, and are not intended to assert or imply any limitation with regard to the environments in which different aspects of the present invention may be implemented. There are other calendar applications, rather than the depicted application, on which aspects of the illustrated embodiments may be implemented.

Referring first to FIG. 6A, calendar entry page 600 is pictured with invitation option 602 selected. Brief description text box 604 indicates that the subject matter of the event is a meeting. Box 606 entitled “not for public viewing” is selected in forming the calendar application that the brief description, as well as other information, may be private information. Responsive to whether box 606 is selected, the calendar application may provide a minimum amount of information necessary to special request service vendors. The invitation list of invitees or attendees 608 lists all of the invitees to the meeting. List 608 indicates that at least attendee 1, attendee 2, and attendee 3 are intended to be attendees of the meeting. Responsive to the “find free time” option in the calendar application, box 610 represents the schedules of the meeting attendees, and includes recommended meeting times 611. In this example calendar application, the attendees' busy times and free times may be differently illustrated, as shown in box 610. Also, in accordance with one or more illustrative embodiments of the present invention, another user of the calendar system, other than a host or invitee, may schedule and invite attendees to the meeting(s).

By way of enhancement, in the illustrated example, the calendar invite is for a specified location, and the scheduler is given the ability to indicate in boxes 615 which invitees or attendees are required to be physically at the specified location for the meeting. In the example depicted in FIG. 6A, three invitees or attendees are identified as being required to be physically present, by way of example only. As explained herein, this information may be used as a further filter in deciding when to schedule an event.

In FIG. 6B, an exemplary calendar entry page 600′ is depicted similar to that described above in connection with FIG. 6A, but with the addition of specific location availability information in box 610 for each invitee or attendee of the meeting. In this example, the electronic calendar system has identified scheduled location availability information for each of the attendees and inserted the information into box 610, where three of the four attendees are identified (in this example) as being in Raleigh, N.C., at the selected date and times, and one in Singapore. Since the three that are co-located in Raleigh for this day and time are identified as the three required in-person for the calendar event to proceed, then the electronic calendar system is able to proceed with inviting the attendees to the event.

FIG. 6C is a page 600″ variation on the calendar entry pages 600, 600′ of FIGS. 6A & 6B, wherein location availability information for each attendee at a specified day and time is displayed in box 610, along with time availability information. As one example, this calendar entry page might be displayed as a result of the user selecting the “view invitee scheduled location availability” button 560 in the graphical user interface window 500 of FIG. 5. As illustrated, the electronic calendar system is able to present a calendar entry page back to the scheduler or user of the calendar application, which itemizes, in one or more implementations, the scheduled location information for each proposed invitee to the calendar event. In this manner, the scheduler is better able to decide whether to proceed with the event at the selected date and time, based on the invitee's location information.

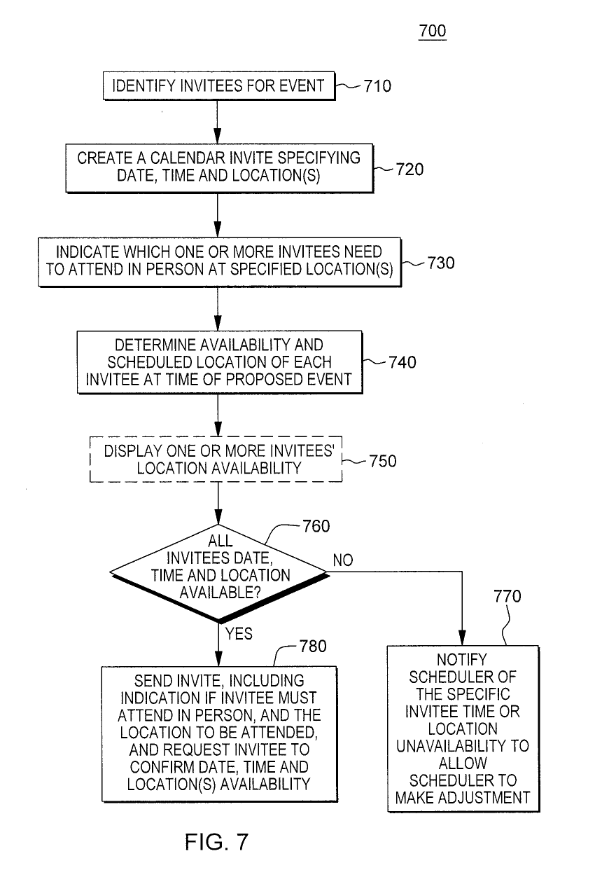

By way of further explanation, FIG. 7 depicts one embodiment of a process 700 for scheduling a calendar event within an electronic calendar system, in accordance with one or more aspects of the present invention. As shown, process 700 includes identifying invitees for an event 710, and creating a calendar invitation specifying a date, time, and one or more locations 720 for the event. Advantageously, the electronic calendar system may be configured to allow the scheduler or user of the calendar application to indicate which one or more invitees need to physically attend the event in person at the specified location(s) 730. Further, the electronic calendar system automatically searches to determine availability of the invitees at the specified location, and at the specified date and time 740. As noted above, this may include referencing invitee scheduled location availability information at one or more calendar applications of the electronic system. Optionally, location availability information for one or more of the invitees may be displayed to, for instance, a scheduler or user of a calendar application initiating the scheduled event 750. Processing determines whether all invitees are available at the selected date, time and location(s) 760. If “no”, then the user or scheduler of the event is notified of the specific invitee time or location unavailability, which allows the user to make an adjustment to the calendar invite 770. Alternatively, if the invitees are available on the selected date, time, and at the specified location(s), then the calendar invite may be sent, including an indication of which invitee(s) is required to attend the event in person at the specified location. The invite may include a request that the invitee confirm the date, time, and location availability 780.

Those skilled in the art will note from the above discussion that electronic calendar scheduling is disclosed herein, with location availability information provided for invitees to a calendar event. The calendar system may have access to specific invitee location information (e.g., in a record, database, etc.), which may be selectively displayed to a scheduler or user attempting to create or manage a calendar event. By way of example, the scheduler may initiate the calendar event and indicate in a box that each invitee is to attend the event in person, or could designate on a per invitee basis who is to attend in person. Still further, the location availability information may be used to specify more than one location for the event. For instance, people on different continents may be instructed to attend the event at a specific geographic location on their respective continent. Privacy features may be combined with managing calendar scheduling based on location availability where desired, similar to privacy for event details when busy during a time slot in existing electronic calendar systems.

By way of further example, a method, system, and computer program product are disclosed herein, which may include initiating scheduling, using an electronic calendar system, of a calendar event for an event to occur at multiple locations at a future time. The initiating scheduling may include: identifying by the scheduler the multiple locations for the event at the future time, and identifying invitees to the calendar event. The electronic calendar system determines location availability of the invitees for the event at one or more of the identified locations for the event at the future time. Once all invitees (or at least those invitees indicated by the scheduler as required in person to attend one of the locations) are location available, then a calendar invite to the invitees may be sent. Note in this regard that location availability of the invitees may be compared against the multiple locations, that is, the group of locations designated by the scheduler for the event at the future time.

As a specific example, the multi-location scenario could be an all-hands type of conference, at which confidential information is to be discussed or relayed, and for which invitees are to be physically present at one of the designated locations. For instance, such an event may involve employees in three or more sites, such as, for instance, Raleigh, N.C., Dublin, Ireland, and Stuttgart, Germany. A scheduler, using the electronic calendar system, would identify, for instance, at least those three locations, as the multiple locations for the event and identify specific buildings and meeting rooms for each of those locations in the user interface of the electronic calendar system for creating or managing the calendar invite. As part of initiating the scheduling, the electronic calendar system may automatically check each invitees' location availability information in the system against the group of available event locations (three in this example) to determine each invitees' availability for the event at the future time. In this way, the invitees' location availability may be cross-checked against the identified multiple locations for the event to determine location availability of each invitee, as well as date and time availability. Note in this regard that an employee typically working out of Raleigh, N.C., might be temporarily working out of Dublin, Ireland, at the future time, and thereby have availability for attending the event in Dublin, Ireland, but not in Raleigh, N.C. As such, the scheduler's ability to designate multiple locations for invitees who are required to attend in person, and the ability of the electronic calendar system to check location availability of each invitee, facilitates scheduling of the event at the multiple locations at some future time.

Additionally, in another example, the multiple locations identified by the scheduler through the electronic calendar system may be, for instance, different locations within a same state. As such, an invitee who may typically work at home may be provided with the ability to designate which location of the multiple locations that invitee will attend in person.

Still further, the electronic calendar system may be provided with a facility to track multiple location availabilities of an invitee. For instance, where the multiple locations are within a common state, an invitee may be for part of a workday at one location, but for a remainder of the day, be available at one of the designated locations of the multiple locations. For instance, the invitee may be located within an acceptable drive time from one of the multiple locations identified by the scheduler. Still further, the electronic calendar system could be provided with the ability for the invitees themselves to designate multiple location availabilities at a future time where, for instance, the invitee's schedule is open, and the invitee is able to be at any one of a number of locations (e.g., while still performing their job). These aspects of the present invention may advantageously be employed in combination with the above-noted facility for the scheduler to identify which invitees of an event are required to attend in person.

One or more aspects may relate to or use cloud computing.

It is understood in advance that although this disclosure includes a detailed description on cloud computing, implementation of certain teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

A cloud computing node may include a computer system/server, such as the one depicted in FIGS. 1-2, wherein the computer system/server may be practiced in distributed cloud computing environments where tasks are performed by remote processing devices that are linked through a communications network. In a distributed cloud computing environment, program modules may be located in both local and remote computer system storage media including memory storage devices. The depicted computer system/server is capable of being implemented and/or performing any of the functionality set forth hereinabove.

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

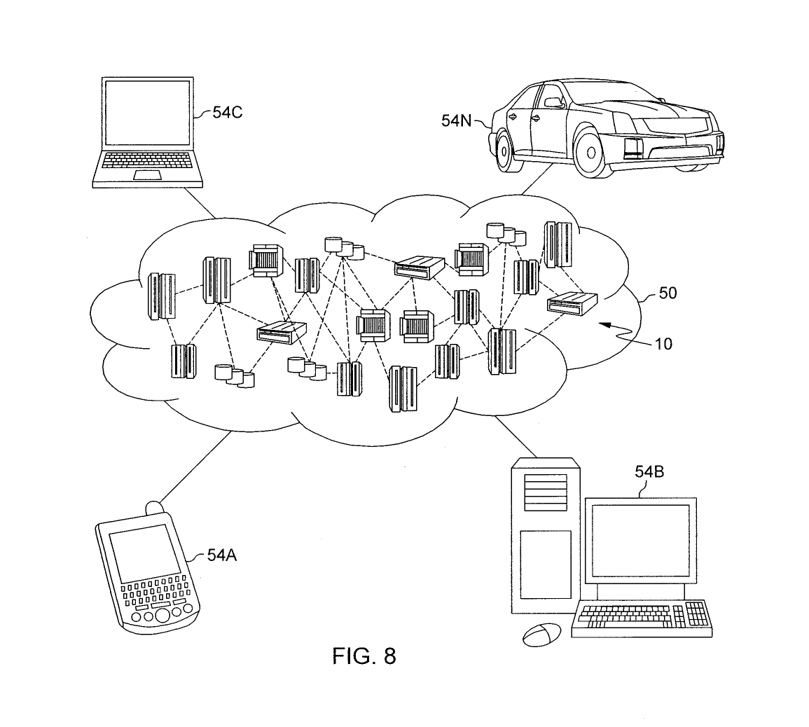

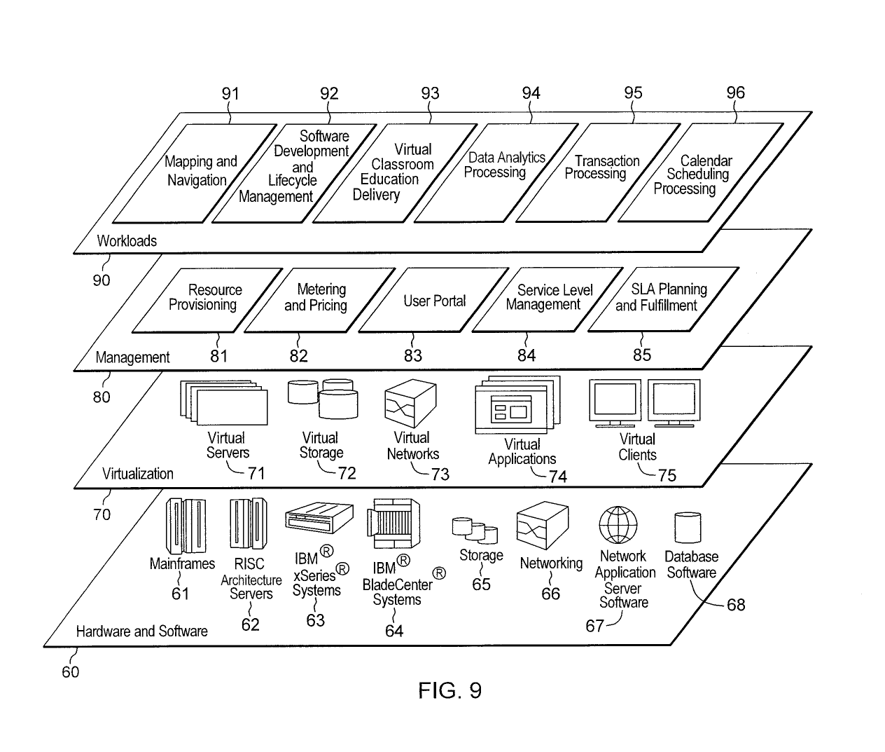

Referring now to FIG. 8, a set of functional abstraction layers provided by cloud computing environment 50 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and calendar scheduling processing 96.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A method comprising:
initiating scheduling, using an electronic calendar system, a calendar event for an event at a location at a future time, the initiating scheduling including:
identifying one or more invitees to the calendar event;
determining, via the electronic calendar system, location availability of the one or more invitees for the event at the future time; and
sending a calendar invite to the one or more invitees based, at least in part, on the one or more invitees being location available for the event at the location at the future time.

2. The method of claim 1, wherein the initiating scheduling further comprises specifying by a scheduler the location for the event using the electronic calendar system, wherein the location is a specified geographic location for the event.

3. The method of claim 2, wherein the initiating scheduling further comprises selectively indicating which invitee(s) of the one or more invitees is required to physically attend the event at the specified geographic location.

4. The method of claim 1, wherein the determining further comprises ascertaining geographically, via the electronic calendar system, a scheduled location of an invitee of the one or more invitees at the future time.

5. The method of claim 1, wherein the determining further comprises ascertaining, via the electronic calendar system, each invitee's scheduled location at the future time, and proceeding with the sending of the calendar invite based on each invitee's scheduled location matching the location for the event at the future time.

6. The method of claim 1, further comprising identifying the location for the event at the future time based, at least in part, on determining the location availability of the one or more invitees at the future time using the electronic calendar system.

7. The method of claim 1, wherein the identifying comprises identifying a plurality of invitees to the calendar event, the plurality of invitees comprising the one or more invitees, and wherein the determining further comprises referencing, via the electronic calendar system, location availability information for the plurality of invitees to identify multiple locations for the event based, at least in part, on scheduled locations of the plurality of invitees at the future time, the location for the event being one location of the plurality of locations for the event.

8. The method of claim 1, further comprising displaying scheduled location availability information of the one or more invitees at the future time for viewing by a scheduler of the calendar event using the electronic calendar system.

9. A system of electronic calendar scheduling, the system comprising:
a memory; and
a processing circuit communicatively coupled with the memory, wherein the system performs a method comprising:
initiating scheduling of a calendar event for an event at a location at a future time, the initiating scheduling including:
identifying one or more invitees to the calendar event;
determining location availability of the one or more invitees for the event at the future time; and
sending a calendar invite to the one or more invitees based, at least in part, on the one or more invitees being location available for the event at the location at the future time.

10. The system of claim 9, wherein the initiating scheduling further comprises specifying by a scheduler the location for the event, wherein the location is a specified geographic location for the event.

11. The system of claim 10, wherein the initiating scheduling further comprises selectively indicating which invitee(s) of the one or more invitees is required to physically attend the event at the specified geographic location.

12. The system of claim 9, wherein the determining further comprises ascertaining geographically a scheduled location of an invitee of the one or more invitees at the future time for comparison against the location for the event at the future time.

13. The system of claim 9, wherein the determining further comprises ascertaining each invitee's scheduled location at the future time, and proceeding with the sending of the calendar invite based on each invitee's scheduled location matching the location for the event at the future time.

14. The system of claim 9, further comprising identifying the location for the event at the future time based, at least in part, on determining the location availability of the one or more invitees at the future time.

15. The system of claim 9, wherein the identifying comprises identifying a plurality of invitees to the calendar event, the plurality of invitees comprising the one or more invitees, and wherein the determining further comprises referencing location availability information for the plurality of invitees at the future time to identify multiple locations for the event based, at least in part, on scheduled locations of the plurality of invitees at the future time, the location for the event being one location of the plurality of locations for the event.

16. The system of claim 9, further comprising displaying scheduled location availability information of the one or more invitees at the future time for viewing by a scheduler of the calendar event.

17. A computer program product for electronic calendar scheduling, the computer program product comprising:
a computer readable storage medium readable by a processing circuit and storing instructions for execution by the processing circuit for performing a method comprising:
initiating scheduling of a calendar event for an event at a location at a future time, the initiating scheduling including:
identifying one or more invitees to the calendar event;
determining location availability of the one or more invitees for the event at the future time; and
sending a calendar invite to the one or more invitees based, at least in part, on the one or more invitees being location available for the event at the location at the future time.

18. The computer program product of claim 17, wherein the determining further comprises ascertaining geographically a scheduled location of an invitee of the one or more invitees at the future time.

19. The computer program product of claim 17, wherein the determining further comprises ascertaining each invitee's scheduled location at the future time, and proceeding with the sending of the calendar invite based on each invitee's scheduled location matching the location for the event at the future time.

20. The computer program product of claim 17, further comprising displaying scheduled location availability information of the one or more invitees at the future time for viewing by a scheduler of the calendar event.
